(19) United States
(12) Patent Application Publication
(10) Pub. No.: US 2021/0132963 A1
(43) Pub. Date: May 6, 2021

(54) SYSTEM AND METHOD FOR PRESENTING NOTIFICATIONS ON HEAD-MOUNTED DISPLAY DEVICE AND EXTERNAL COMPUTING DEVICE

(71) Applicant: Varjo Technologies Oy, Helsinki (FI)

(72) Inventors: Ari Antti Peuhkurinen, Helsinki (FI); Matias Hyry, Vantaa (FI)

(21) Appl. No.: 16/674,173

(22) Filed: Nov. 5, 2019

(51) Int. Cl. G06F 9/451; G02B 27/01; G06F 11/07; H04L 12/58

(52) U.S. Cl. CPC G06F 9/451; G02B 27/017; H04L 51/24; G06F 11/0793; G06F 11/0769

(57) ABSTRACT

A system for presenting notifications on display device and external computing device. The display device includes image renderer, external visual indicator and first processor, the external computing device comprises display and second processor. The system comprises first and second clients executing on first processor, third client executing on second processor, first, second and third clients are configured to generate and render first, second and third user interfaces on image renderer, external visual indicator and display, respectively; and control server. The control server is configured to obtain information; detect whether or not notification is to be presented; determine notification type and content; and select clients from amongst plurality of clients and send content on selected clients, wherein selected clients are configured to generate and render their respective user interfaces to present notification substantially simultaneously.

### TECHNICAL FIELD

The present disclosure relates generally to systems for presenting notifications; and more specifically, to systems for presenting notifications on head-mounted display devices and external computing devices, wherein said systems comprises plurality of clients and control servers. The present disclosure also relates to methods for presenting notifications on head-mounted display devices and external computing devices.

### BACKGROUND

Presently, several technologies (for example, such as virtual reality (VR), augmented reality (AR), mixed reality (MR) and the like) are being used to present interactive extended-reality environments to users. Typically, the users utilize specialized devices (for example, such as a virtual reality device, an augmented reality device, a mixed reality device, and the like) for experiencing and interacting with such extended-reality environments. In use, the user generally wears the specialized device on his/her head.

Generally, such specialized devices work in communication with external computing devices (such as a desktop computer, a mobile device, and the like) in order to display information associated with working status and errors associated with the specialized devices as well as the external computing devices. However, there exists certain limitations associated with the display of the information regarding the working status. Firstly, the information displayed on the specialized devices and the external computing devices may not be consistent. For example, the specialized device may be showing an error associated with a display screen and the external computing device fails to recognize such error. Secondly, there may be a noticeable time-lag, for example, of about 100 milliseconds, between the information displayed on the specialized devices and the external computing devices. Consequently, in such a case, the user may get troubled regarding an actual status of the specialized devices and the external computing devices, and often gets confused. In particular, the user is unable to appropriately react to such inconsistent information.

Therefore, in light of the foregoing discussion, there exists a need to overcome the aforementioned drawbacks associated with presenting simultaneous and consistent information on specialized devices and external computing devices.

### SUMMARY

The present disclosure seeks to provide a system for presenting notifications on a head-mounted display device and at least one external computing device. The present disclosure also seeks to provide a method for presenting notifications on a head-mounted display device and at least one external computing device. The present disclosure seeks to provide a solution to the existing problem associated with presenting consistent information simultaneously on display devices and external computing devices. An aim of the present disclosure is to provide a solution that overcomes at least partially the problems encountered in prior art, and provides an efficient and reliable system for presenting notifications on a head-mounted display device and at least one external computing device.

In one aspect, an embodiment of the present disclosure provides a system for presenting notifications on a head-mounted display device and at least one external computing device, the display device comprising at least one image renderer, an external visual indicator and a first processor, the at least one external computing device comprising a display and a second processor, the at least one external computing device being communicably coupled with the display device, wherein the system comprises:

a plurality of clients, a first client and a second client from amongst the plurality of clients executing on the first processor, a third client from amongst the plurality of clients executing on the second processor, wherein the first client, the second client and the third client are configured to generate and render a first user interface, a second user interface and a third user interface on the at least one image renderer, the external visual indicator and the display, respectively; and

a control server executing on the first processor or the second processor, wherein the control server is configured to:

obtain information indicative of at least one of: a current status of an extended-reality scene being presented via the at least one image renderer, an error encountered by the display device, an error encountered by the at least one external computing device, a user input received by the display device, a user input received by the at least one external computing device;

detect, based on the obtained information, whether or not a notification is to be presented;

determine, based on the obtained information, a notification type and content of the notification when it is detected that the notification is to be presented; and

select, based on the notification type, at least two clients from amongst the plurality of clients and send the content of the notification to the at least two clients, wherein the at least two clients are configured to generate and render their respective user interfaces, based on the content of the notification, to present the notification substantially simultaneously.

In another aspect, an embodiment of the present disclosure provides a method of presenting notifications on a head-mounted display device and at least one external computing device, the display device comprising at least one image renderer, an external visual indicator and a first processor, the at least one external computing device comprising a display and a second processor, the at least one external computing device being communicably coupled with the display device, wherein a first client and a second client from amongst a plurality of clients are executed on the first processor to generate and render a first user interface and a second user interface on the at least one image renderer and the external visual indicator, respectively, and wherein a third client from amongst the plurality of clients is executed on the second processor to generate and render a third user interface on the display, wherein the method comprises:
obtaining, at a control server executing on the first processor or the second processor, information indicative of at least one of: a current status of an extended-reality scene being presented via the at least one image renderer, an error encountered by the display device, an error encountered by the at least one external computing device, a user input received by the display device, a user input received by the at least one external computing device;

detecting, at the control server, whether or not a notification is to be presented, based on the obtained information;

determining, at the control server, a notification type and content of the notification when it is detected that the notification is to be presented, wherein the notification type and the content of the notification are determined based on the obtained information;

selecting, at the control server, at least two clients from amongst the plurality of clients based on the notification type and sending the content of the notification to the at least two clients; and generating, at the at least two clients, their respective user interfaces based on the content of the notification, and rendering their respective user interfaces to present the notification substantially simultaneously.

Embodiments of the present disclosure substantially eliminate or at least partially address the aforementioned problems in the prior art, and enable substantially simultaneous presentation of notifications on a display device and external computing devices.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a schematic illustration of an exemplary environment wherein a system for presenting notifications on a head-mounted display device and at least one external computing device is implemented, in accordance with an embodiment of the present disclosure;

FIG. 2 illustrates block diagrams of architectures of a system for presenting notifications on a head-mounted display device and at least one external computing device, in accordance with an embodiment of the present disclosure;

FIG. 3 illustrates steps of a method of presenting notifications on a head-mounted display device and at least one external computing device, in accordance with an embodiment of the present disclosure; and

FIG. 4 illustrates steps of method of presenting notifications on a head-mounted display device and at least one external computing device when a client detects whether or not notification is presented, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a system for presenting notifications on a head-mounted display device and at least one external computing device, the display device comprising at least one image renderer, an external visual indicator and a first processor, the at least one external computing device comprising a display and a second processor, the at least one external computing device being communicably coupled with the display device, wherein the system comprises:

a plurality of clients, a first client and a second client from amongst the plurality of clients executing on the first processor, a third client from amongst the plurality of clients executing on the second processor, wherein the first client, the second client and the third client are configured to generate and render a first user interface, a second user interface and a third user interface on the at least one image renderer, the external visual indicator and the display, respectively; and

a control server executing on the first processor or the second processor, wherein the control server is configured to:

obtain information indicative of at least one of: a current status of an extended-reality scene being presented via the at least one image renderer, an error encountered by the display device, an error encountered by the at least one external computing device, a user input received by the display device, a user input received by the at least one external computing device;

detect, based on the obtained information, whether or not a notification is to be presented;

determine, based on the obtained information, a notification type and content of the notification when it is detected that the notification is to be presented; and

select, based on the notification type, at least two clients from amongst the plurality of clients and send the content of the notification to the at least two clients, wherein the at least two clients are configured to generate and render their respective user interfaces, based on the content of the notification, to present the notification substantially simultaneously.

In another aspect, an embodiment of the present disclosure provides a method of presenting notifications on a head-mounted display device and at least one external computing device, the display device comprising at least one image renderer, an external visual indicator and a first processor, the at least one external computing device comprising a display and a second processor, the at least one external computing device being communicably coupled with the display device, wherein a first client and a second client from amongst a plurality of clients are executed on the first processor to generate and render a first user interface and a second user interface on the at least one image renderer and the external visual indicator, respectively, and wherein a third client from amongst the plurality of clients is executed on the second processor to generate and render a third user interface on the display, wherein the method comprises:

obtaining, at a control server executing on the first processor or the second processor, information indicative of at least one of: a current status of an extended-reality scene being presented via the at least one image renderer, an error encountered by the display device, an error encountered by the at least one external computing device, a user input received by the display device, a user input received by the at least one external computing device;

detecting, at the control server, whether or not a notification is to be presented, based on the obtained information;

determining, at the control server, a notification type and content of the notification when it is detected that the notification is to be presented, wherein the notification type and the content of the notification are determined based on the obtained information;

selecting, at the control server, at least two clients from amongst the plurality of clients based on the notification type and sending the content of the notification to the at least two clients; and

generating, at the at least two clients, their respective user interfaces based on the content of the notification, and rendering their respective user interfaces to present the notification substantially simultaneously.

The present disclosure provides the aforementioned system and method for presenting notifications on a head mounted-display device and at least one external computing device communicably coupled with the display device. The aforementioned system is intelligent, easy to implement, and allows for presenting consistent information (regarding current statuses) as notifications to user(s) of the head mounted-display device and the at least one external computing device. Moreover, the system is configured to send the notifications to the head mounted-display device and the at least one external computing device in a synchronized manner. As a result, the user(s) of the head mounted-display device and the at least one external computing device views the notification without any time-lag. Such consistent notifications avoid any confusion associated with current statuses of the head mounted-display device and the at least one external computing device. This further improves overall user experience while using the head mounted-display device and/or the external computing device. Moreover, the method described herein is computationally efficient.

Throughout the present disclosure, the term “head-mounted display device” refers to a specialized equipment that is configured to present a simulated environment to the user when the display device in operation is worn by the user on his/her head. In such an instance, the display device acts as a device (for example, such as a virtual reality headset, a pair of virtual reality glasses, an augmented reality headset, a pair of augmented reality glasses, a mixed reality headset, a pair of mixed reality glasses, and the like) that is operable to present a visual scene of the simulated environment to the user. The head-mounted display device may also commonly be referred to as “display device”.

Throughout the present disclosure, the term “image renderer” refers to equipment that, in operation, renders images that are to be displayed to the user of the display device. It will be appreciated that the term “at least one image renderer” refers to “one image renderer” in some implementations, and “a plurality of image renderers” in other implementations.

Optionally, the at least one image renderer is implemented as at least one display. In such a case, the at least one display is selected from the group consisting of: a Liquid Crystal Display (LCD), a Light Emitting Diode (LED)-based display, an Organic LED (OLED)-based display, a micro OLED-based display, a Liquid Crystal on Silicon (LCoS)-based display, a Cathode Ray Tube (CRT)-based display, Digital Light Processing (DLP)-based display.

Optionally, the at least one image renderer is implemented as at least one projector. In such a case, the images are projected onto a projection screen. The at least one projector is selected from the group consisting of: an LCD-based projector, an LED-based projector, an OLED-based projector, an LCoS-based projector, a Digital Light Processing (DLP)-based projector, and a laser projector.

Throughout the present disclosure the term, “external visual indicator” refers to equipment configured to provide a visual signal to a viewer present in the user's surroundings. In particular, the external visual indicator is arranged on an outer surface of the display device, so as to be visible to the viewer present in the user's surroundings, particularly when the user is wearing the display device. Optionally, the eternal visual indicator comprises a world-facing display (namely, a display screen) that is arranged on the outer surface of the display device. Optionally, the external visual indicator comprises at least one light-emitting element that is arranged on the outer surface of the display device. The light-emitting element refers to a light source configured to emit light provide the visual signal in order to indicate a given notification associated with the display device. A color and/or an intensity of light emitted by the at least one light-emitting element can be controlled to create different visual cues, associated with different types of notifications. As an example, the color of the at least one light-emitting element can be controlled to create a given color sequence, thereby indicating a particular notification. The at least one light emitting element is implemented by way of at least one of: light emitting diodes, light lasers, light projectors, and the like.

Throughout the present disclosure, the term “first processor” refers to hardware, software, firmware or a combination of these, suitable for controlling the operation of the display device. The first processor is communicably coupled to the at least one image renderer and the external visual indicator of the display device wirelessly and/or in a wired manner.

Throughout the present disclosure, the term “external computing device” refers to a device that is capable of performing computational tasks associated with the display device. Notably, the at least one external computing device is communicably coupled to the display device, wirelessly and/or in a wired manner. Examples of the external computing device include, but are not limited to, a mobile phone, a smart telephone, a smart watch, a television, a car in-vehicle infotainment (IVI), a Mobile Internet Device (MID), a tablet computer, an Ultra-Mobile Personal Computer (UMPC), a phablet computer, a Personal Digital Assistant (PDA), a web pad, a Personal Computer (PC), a handheld PC, a laptop computer, a tablet computer, and a desktop computer. It will be appreciated that the term “at least one external computing device” refers to “one external computing device” in some implementations, and “a plurality of external computing devices” in other implementations.

Throughout the present disclosure, the term “display” of the external computing device refers to equipment that, in operation, displays images that are to be shown to the user of the external computing device. Optionally, the display is selected from the group consisting of: a Liquid Crystal Display (LCD), a Light Emitting Diode (LED)-based display, an Organic LED (OLED)-based display, a micro OLED-based display, and a Liquid Crystal on Silicon (LCoS)-based display.

Throughout the present disclosure, the term “second processor” refers to hardware, software, firmware or a combination of these, suitable for controlling the operation of the at least one external computing device. The second processor is communicably coupled to the display wirelessly and/or in a wired manner.

Throughout the present disclosure, the term “control server” relates to a server that, when operated, performs the aforementioned steps for presenting notifications on the head-mounted display device and the at least one external computing device. The term “server” generally refers to an application, program, process or device in a client-server relationship that responds to requests for information or services by another application, program, process or device (a client) on a communication interface. The term “server” also encompasses software that makes the act of serving information or providing services possible. The term “client” generally refers to an application, program, process or device in a client-server relationship that requests information or services from the server (which is another application, program, process or device) on the communication interface. The term “client” also encompasses software that makes the connection between a requesting application, program, process or device and a server possible, such as an FTP client. It will be appreciated that the communication interface can be a collection of individual interfaces that are interconnected with each other to present consistent information thereon in a synchronized manner.

It will be appreciated that the control server is executed on the display device or the at least one external computing device. In particular, the control server is executed on the first processor of the display device and the second processor of the at least one external computing device.

Notably, the control server is coupled in communication with the plurality of clients. In some implementations, the plurality of clients comprises a first client, a second client, and a third client, wherein the first client and the second client execute on the display device, and the third client executes on an external computing device. In other implementations, the plurality of clients comprises a first client, a second client, a third client, and a fourth client, wherein the first client and the second client execute on the display device, the third client executes on an external computing device, and the fourth client executes on another external computing device. In yet other implementations, the plurality of clients comprises more than four clients.

For sake of simplicity and clarity, we have taken a basic case of having three clients. The first client, the second client and the third client are configured to generate and render the first user interface, the second user interface and the third user interface on the at least one image renderer, the external visual indicator and the display, respectively. It will be appreciated that a number of user interfaces correspond to a number of clients. Notably, the control server is configured to display consistent information on the said user interfaces in a synchronized manner. Throughout the present disclosure, the term “user interface” refers to a space that allows for interaction between the user and a machine. Notably, the user interface enables in receiving input(s) from and/or providing output(s) to the user. The term “user interface” can also be referred to as a “human-machine interface”. In particular, the first user interface, the second user interface and the third user interface allow for interaction of user with the at least one image renderer, the external visual indicator and the at least one external computing device, respectively.

Notably, a software application executing on the first processor (namely, of the display device) or the second processor (namely, of the at least one external computing device) is configured to generate extended-reality (XR) images to be rendered via the at least one image renderer. Such XR images presents an extended-reality view to the user when the display device is worn by the user. It will be appreciated that the term “extended-reality” encompasses virtual reality, augmented reality, mixed reality, and the like. In some implementations, the software application could be executed entirely on the second processor (for example, a PC). In such implementations, the software application is different from the plurality of clients (namely, client applications) that are configured to generate the user interfaces.

The control server is configured to obtain the information indicative of the at least one of: the current status of the extended-reality scene being presented via the at least one image renderer, the error encountered by the display device, the error encountered by the at least one external computing device, a user input received by the display device, a user input received by the at least one external computing device. Throughout the present disclosure, the term “current status” refers to an operating condition (namely, a status) of the display device or the at least on external computing device. For example, the current status may indicate whether or not the display device or the at least on external computing device is turned on. In an example, the current status of the extended-reality scene that is presented via the at least one image renderer may, for example, indicate that whether or not the user is able to see the XR images rendered via the at least one image renderer.

The error encountered by the display device may, for example, include indications whether or not the components of the display device are working properly, such as whether or not the user is able to hear sounds emerging from the display device. The error encountered by the at least one external computing device may, for example, include indication whether or not the components of the at least one external computing device are working properly, such as audio and/or video content is presented properly on the display or not.

Throughout the present disclosure, the term “user input” refers to an input provided by the user to the display device or the at least one external computing device, via the user interface. In such a case, the user input can be provided using at least one of: a touch input, an audio input, a gesture input. Optionally, the user input is provided by the user using an input area at a given user interface (namely, rendered on the at least one image renderer, the external visual indicator or the display). Optionally, in this regard, the input area comprises at least one of: a user-selectable icon, a user selectable button, an input field, a slider, a dropdown menu. In an example, the user input received by the display device or the at least one external computing device may, for example, indicate that user has selected an input element (namely, an icon) on the corresponding user interface.

The control server is configured to detect, based on the obtained information, whether or not the notification is to be presented. Notably, the control server has its own set of rules to detect whether or not the notification is to be presented. It will be appreciated that presentation of the notification would depend on the criticality of the obtained information. In an example, when the obtained information is an indication of the current status of the display device or the at least one external computing device, the notification may not be critical and is not presented to the user. In another example, when the obtained information is an indication of a potential error or possible error encountered by the display device or the at least one external computing device, the notification may be critical and is presented to the user. In yet another example, when the obtained information is regarding the user input received by the display device or the at least one external computing device, in such instance the control server may detects that the notification need not be presented to the user. Optionally, the control server is configured to employ at least one artificial intelligence algorithm to detect whether or not the notification is to be presented. Such artificial intelligence algorithms are well known in the art.

Throughout the present disclosure the term “notifications” refer to an indication associated with the information related to working of the display device or the at least on external computing device to draw user's attention. In particular, the notifications are presented by the system on the display device or the at least one external device to inform the user regarding the obtained information. In an example, the notification may be presented in form of a light indication, for example, when the obtained information is regarding any error experienced or to be experienced by the display device or the at least on external computing device. Alternatively, the notification may be presented in form of a text message.

Optionally, the notification indicates at least one of: an error code of an error encountered by the display device or the at least one external computing device, an action to be taken by the user to fix the error, technical details related to the error. In particular, the notification indicates information associated with technical errors encountered by the display device or the at least one external computing device and details associated therewith. The error code of the error encountered by the display device or the at least one external computing device may include alphanumeric code associated with at least one error. In an example, the notification may indicate error code 8528, 8521, 8421A and so on. In such an, the technical details related to the error 8528 may represent whether or not the at least one image renderer or the display are compatible or working properly, the error code 8521 may represent whether or not video is recorded or image is captured of the surroundings of the user, and the error code 8421A may represent whether or not images are exported to the display device and the at least one external computing device. Moreover, the action to be taken by the user to fix said errors may be provided by the notification such as contact an operator, reset the display device or the at least one external computing device, and the like.

The control server when detects that the notification is to be presented, the control server is configured to determine, based on the obtained information, the notification type and the content of the notification. Throughout the present disclosure, the term “notification type” refers to type of information that is to be presented on the display device or the at least one external computing device. For example, the notification type may be one of: a critical type, a moderate type, a non-critical type. It will be appreciated that based on the notification type, a duration for which the notification is to be presented, an area of the user interface to be covered by the notification, and the like, may be selected. In an example, a duration for which the critical type notification is to be presented will be more as compared to a duration for which the non-critical type notification is to be presented. Similarly, an area of the user interface to be covered by the critical type notification will be large as compared to an area of the user interface to be covered by the non-critical type notification.

Throughout the present disclosure, the term “notification content” refers to information that is to be presented on the display device or the at least one external computing device. Optionally, the content of the notification comprises at least one of: text, an image, a video clip, an audio clip, a Uniform Resource Locator (URL) link. In an example, the content of the notification may be provided in form of a text message such as an error code. In another example, the content of the notification may be provided in form of a video clip or an image that is to be shown to the user. In yet another example, the content of the notification may be provided in form of a URL that a user may need to visit in order to fix the error.

The control server is configured to select, based on the notification type, at least two clients from amongst the plurality of clients and send the content of the notification to the at least two clients wherein the at least two clients are configured to generate and render their respective user interfaces, based on the content of the notification, to present the notification substantially simultaneously. In particular, the control server is configured to generate a notification receiver (namely, a client) list based on the notification type. Thereafter, the content of the notification is sent to only the selected clients that are included in the notification receiver list. As a result, the selected clients generate and render their respective user interfaces to present the notification substantially simultaneously.

By “substantially simultaneously”, it is meant that time instants, at which the user interfaces generated by the at least two clients are rendered, lie within 100 milliseconds from each other, and more optionally, within 50 milliseconds from each other, and yet more optionally, within 20 milliseconds from each other.

Optionally, the control server is configured to define a plurality of notification types and associate with a given notification type at least two clients from amongst the plurality of clients that are configured to generate notifications of the given notification type. Notably, a given client is configured to show a given notification type. It will be appreciated that the given notification may not be presented to each of the plurality of clients. In some implementations, it may not be important for a given client to present a given type and content of the notification. Therefore, in such a case, the control server is configured to select the clients among the plurality of clients in order to present the notifications. Beneficially, the substantially simultaneous presentation of the notification facilitates synchronization between the user interfaces.

Optionally, the control server is configured to:

determine, based on the notification type, an expiration time of the notification; and

trigger the at least two clients to remove the notification when the expiration time of the notification has passed,

wherein, when triggered, the at least two clients are configured to update and render their respective user interfaces to remove the notification substantially simultaneously.

Throughout the present disclosure, the term “expiration time” refers to a given time period after which a notification expires or no longer exists. In this regard, each notification may have a given expiration time associated therewith. When the expiration time of the notification has passed, the control server is configured to trigger (by sending a signal or a message) the at least two clients to remove the notification. In such a case, the control server sends the signal or the message to the selected clients to remove the notification. Thereafter, the selected clients are configured to update and render their respective user interfaces to remove the notification substantially simultaneously.

It will be appreciated that the expiration time of a given notification may be different based on type of notification. For example, an expiration time for the critical type of notification may be higher than an expiration time for the non-critical type of notification.

Optionally, the control server is configured to:

detect whether or not a user has dismissed the notification; and

trigger the at least two clients to remove the notification when it is detected that the user has dismissed the notification,

wherein, when triggered, the at least two clients are configured to update and render their respective user interfaces to remove the notification substantially simultaneously.

Optionally, in this regard, the user dismisses the notification to be presented on the display device or the at least one external computing device after which a notification no longer exists. In such a case, the user may dismiss the notification, for example, such as by providing the user input on the display device or the at least one external computing device via their respective user interfaces. Moreover, in such a case the obtained information comprises the user input received by the display device or the at least one external computing device, wherein the user input indicates that the user has dismissed a notification message on the display device or the a least one external computing device.

Optionally, a given client from amongst the plurality of clients is configured to:

detect whether or not a notification is to be presented; and

send, to the control server, information about the notification when it is detected that the notification is to be presented, wherein the control server is configured to:

determine, based on the information about the notification, a notification type and content of the notification; and

select, based on the notification type, at least two clients from amongst the plurality of clients and send the content of the notification to the at least two clients, wherein the at least two clients comprise the given client, wherein the at least two clients are configured to generate and render their respective user interfaces, based on the content of the notification, to present the notification substantially simultaneously.

Optionally, in this regard, the given client from amongst the plurality of clients act as a notification setter. In particular, the notification setter and detects whether or not the notification is required to be presented. When the notification is to be presented, the given client informs the control server. Thereafter, the control server is configured to determine the type and content of the notification. Based upon the determined type and content of the notification the control server is configured to determine the at least two clients among the plurality of clients to generate and render the user interfaces to present notification substantially simultaneously. For example, the first client may know information related to the display errors and notifications, thereby sending information to the control server to present the notification.

Optionally, the given client is configured to send, to the control server, a message indicating when the notification is to be removed, wherein the control server is configured to trigger the at least two clients to remove the notification, based on the message, wherein, when triggered, the at least two clients are configured to update and render their respective user interfaces to remove the notification substantially simultaneously.

Optionally, in this regard, when the given client from amongst the plurality of clients sends a message to the control server indicating when the notification is to be removed, the control server is configured to trigger the at least two clients by sending a signal or message to the corresponding clients to remove the notification. In such a case, the corresponding clients are configured to update and render their respective user interfaces to remove the notification in a synchronized manner.

Optionally, the control server configured to generate a notification setter list (which may include listing of the plurality of clients) based on the obtained information. Thereafter, the notification is sent to only the selected clients that are included in the notification setter list. As a result, the selected clients generate and render their respective user interfaces to present the notification in a synchronized manner.

The present disclosure also relates to the method as described above. Various embodiments and variants disclosed above apply mutatis mutandis to the method.

Optionally, the method further comprises:

determining, at the control server, an expiration time of the notification based on the notification type; and

triggering the at least two clients to remove the notification when the expiration time of the notification has passed, wherein the at least two clients update and render their respective user interfaces to remove the notification substantially simultaneously.

Optionally, the method further comprises:

detecting, at the control server, whether or not a user has dismissed the notification; and

triggering the at least two clients to remove the notification when it is detected that the user has dismissed the notification, wherein the at least two clients update and render their respective user interfaces to remove the notification substantially simultaneously.

Optionally, the method further comprises:

detecting, at a given client from amongst the plurality of clients, whether or not a notification is to be presented;

sending, to the control server, information about the notification when it is detected that the notification is to be presented;

determining, at the control server, a notification type and content of the notification based on the information about the notification;

selecting, at the control server, at least two clients from amongst the plurality of clients based on the notification type and sending the content of the notification to the at least two clients, wherein the at least two clients comprise the given client; and

generating, at the at least two clients, their respective user interfaces based on the content of the notification, and rendering their respective user interfaces to present the notification substantially simultaneously.

Optionally, the method further comprises:

sending, from the given client to the control server, a message indicating when the notification is to be removed; and

triggering the at least two clients to remove the notification based on the message, wherein the at least two clients update and render their respective user interfaces to remove the notification substantially simultaneously.

Optionally, the method further comprises:

defining, at the control server, a plurality of notification types; and

associating with a given notification type at least two clients from amongst the plurality of clients that are configured to generate notifications of the given notification type.

Optionally, in the method, the content of the notification comprises at least one of: text, an image, a video clip, an audio clip, a Uniform Resource Locator (URL) link.

Optionally, in the method, the notification indicates at least one of: an error code of an error encountered by the display device or the at least one external computing device, an action to be taken by the user to fix the error, technical details related to the error.

### DETAILED DESCRIPTION OF THE DRAWINGS

Referring to FIG. 1, illustrated is a schematic illustration of an exemplary environment 100 wherein a system for presenting notifications on a head-mounted display device (not shown) and at least one external computing device (not shown) is implemented, in accordance with an embodiment of the present disclosure. The system 100 comprises a plurality of clients (depicted as a first client 102A, a second client 102B, a third client 102C and a fourth client 102D) and a control server 104. The first client 102A and a second client 102B executing on a first processor (of the display device), the third client 102C executing on a second processor (of an external computing device), the fourth client 102D executing on a third processor (of another external computing device), wherein the first client 102A, the second client 102B, the third client 102C and the fourth client 102D are configured to generate and render a first user interface (not shown), a second user interface (not shown), a third user interface (not shown) and a fourth user interface (not shown). The control server 104 executes on the first processor, the second processor or the third processor.

It will be appreciated that FIG. 1 is merely an example, which should not unduly limit the scope of the claims herein. It is to be understood that the specific designation for the environment 100 is provided as an example and is not to be construed as limiting the environment 100 to specific numbers, types, or arrangements of plurality of clients. A person skilled in the art will recognize many variations, alternatives, and modifications of embodiments of the present disclosure.

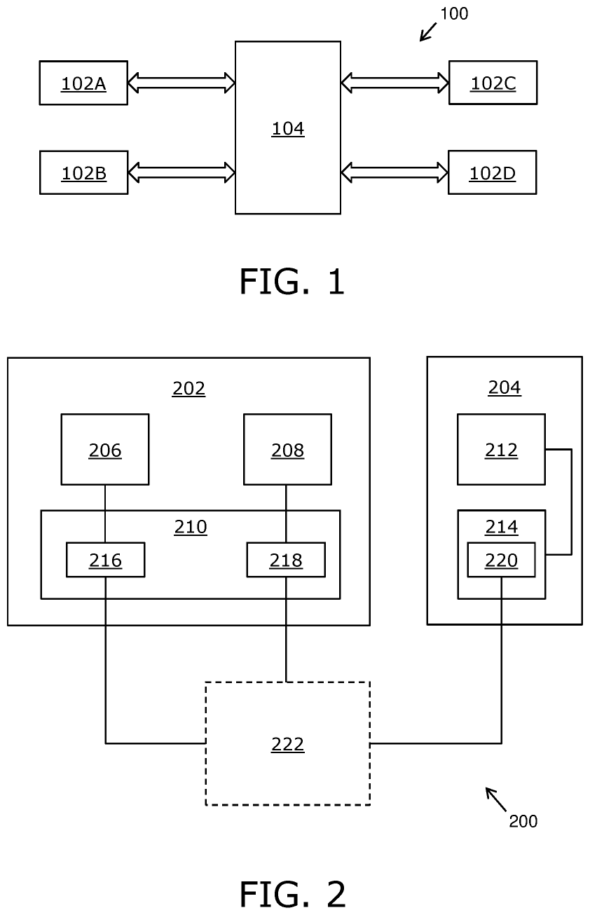

Referring to FIG. 2, illustrated is a block diagram of architecture of the system 200 for presenting notifications on a head-mounted display device 202 and at least one external computing device (depicted as an external computing device 204), in accordance with embodiments of the present disclosure. The display device 202 comprises at least one image renderer (depicted as an image renderer 206), an external visual indicator 208 and a first processor 210, the external computing device 204 comprises a display 212 and a second processor 214, the external computing device 204 being communicably coupled with the display device 202. The system 200 comprises a plurality of clients (depicted as a first client 216, a second client 218 and a third client 220) and a control server 222 executing on the first processor 210 or the second processor 214. The first client 216 and a second client 218 executing on the first processor 210, the third client 220 executing on the second processor 214, wherein the first client 216, the second client 218 and the third client 220 are configured to generate and render a first user interface (not shown), a second user interface (not shown) and a third user interface (not shown) on the image renderer 206, the external visual indicator 208 and the display 212, respectively. The control server 222 is configured to:

obtain information indicative of at least one of: a current status of an extended-reality scene being presented via the image renderer 206, an error encountered by the display device 202, an error encountered by the external computing device 204, a user input received by the display device 202, a user input received by the external computing device 204;

detect, based on the obtained information, whether or not a notification is to be presented;

determine, based on the obtained information, a notification type and content of the notification when it is detected that the notification is to be presented; and

select, based on the notification type, at least two clients from amongst the first client 216, the second client 218 and the third client 220 and send the content of the notification to the at least two clients,

wherein the at least two clients are configured to generate and render their respective user interfaces, based on the content of the notification, to present the notification substantially simultaneously.

It will be appreciated that FIG. 2 is merely an example, which should not unduly limit the scope of the claims herein. A person skilled in the art will recognize many variations, alternatives, and modifications of embodiments of the present disclosure.

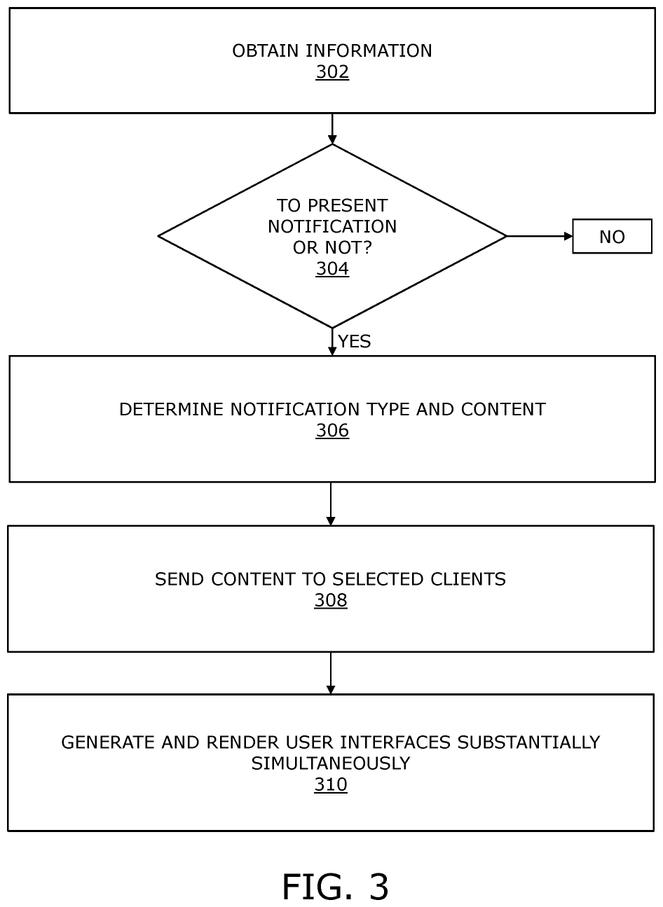

Referring to FIG. 3, illustrated are steps of a method of presenting notifications on a head-mounted display device (not shown) and at least one external computing device (not shown), in accordance with an embodiment of the present disclosure. In the method, the display device comprises at least one image renderer (not shown), an external visual indicator (not shown), and a first processor (not shown), the at least one external computing device comprises a display (not shown) and a second processor (not shown), the at least one external computing device being communicably coupled with the display device. A first client and a second client from amongst a plurality of clients are executed on the first processor to generate and render a first user interface and a second user interface on the at least one image renderer and the external visual indicator, respectively, and wherein a third client from amongst the plurality of clients is executed on the second processor to generate and render a third user interface on the display. At a step 302, information indicative of at least one of: a current status of an extended-reality scene being presented via the at least one image renderer, an error encountered by the display device, an error encountered by the at least one external computing device, a user input received by the display device, a user input received by the at least one external computing device is obtained at a control server executing on the first processor or the second processor. At a step 304, whether or not a notification is to be presented at the control server is detected based on the obtained information. At a step 306, when it is detected that the notification is to be presented, at the control server, a notification type and content of the notification is determined based on the obtained information. At a step 308, at least two clients from amongst the plurality of clients are selected, at the control server, based on the notification type and the content of the notification is sent to the at least two clients. At a step 310, generating, at the at least two clients, their respective user interfaces based on the content of the notification, and rendering their respective user interfaces to present the notification substantially simultaneously.

The steps 302, 304, 306, 308 and 310 are only illustrative and other alternatives can also be provided where one or more steps are added, one or more steps are removed, or one or more steps are provided in a different sequence without departing from the scope of the claims herein.

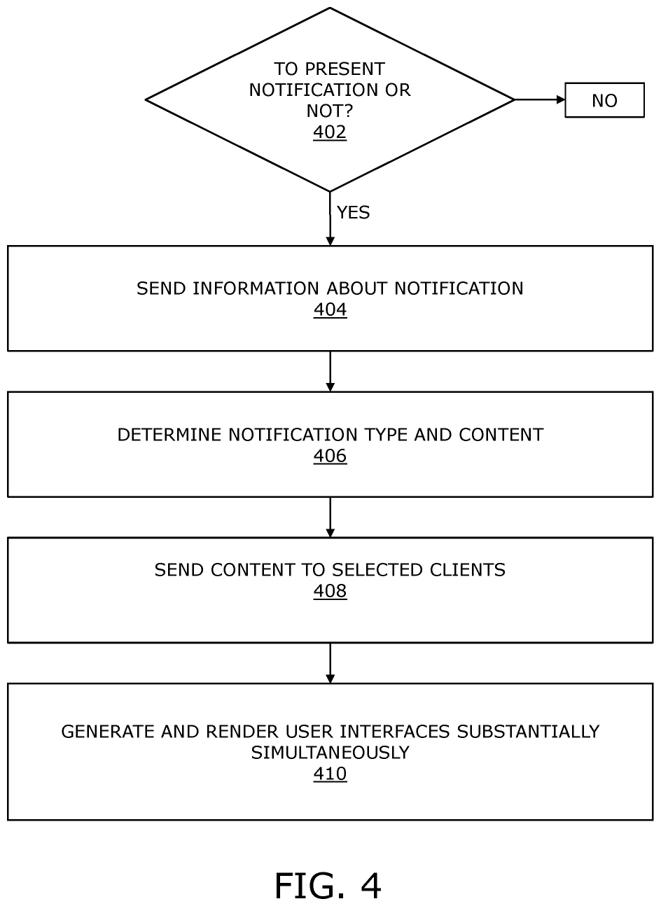

Referring to FIG. 4 illustrated are steps of method of presenting notifications on a head-mounted display device and at least one external computing device when a client detects whether or not notification is presented, in accordance with the embodiments of the present disclosure. At a step 402, whether or not the notification is to be presented at a given client from amongst a plurality of clients is detected. At a step 404, when it is detected that the notification is to be presented information about the notification is sent to a control server. At a step 406, a notification type and content of the notification is determined based on the information about the notification, at the control server. At a step 408, at least two clients from amongst the plurality of clients, at the control server, are selected based on the notification type and the content of the notification is sent to the at least two clients, wherein the at least two clients comprise the given client. At a step 410, at the at least two clients, their respective user interfaces are generated based on the content of the notification, and their respective user interfaces are rendered to present the notification substantially simultaneously.

The steps 402, 404, 406, 408 and 410 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for presenting notifications on a head-mounted display device and at least one external computing device, the display device comprising at least one image renderer, an external visual indicator and a first processor, the at least one external computing device comprising a display and a second processor, the at least one external computing device being communicably coupled with the display device, wherein the system comprises:
a plurality of clients, a first client and a second client from amongst the plurality of clients executing on the first processor, a third client from amongst the plurality of clients executing on the second processor, wherein the first client, the second client and the third client are configured to generate and render a first user interface, a second user interface and a third user interface on the at least one image renderer, the external visual indicator and the display, respectively; and
a control server executing on the first processor or the second processor, wherein the control server is configured to:
obtain information indicative of at least one of: a current status of an extended-reality scene being presented via the at least one image renderer, an error encountered by the display device indicating whether or not the components of the display device are working properly, an error encountered by the at least one external computing device indicating whether or not the components of the at least one external computing device are working properly, a user input received by the display device indicating an icon selection, a user input received by the at least one external computing device indicating an icon selection;
detect, based on the obtained information, whether or not a notification is to be presented;
determine, based on the obtained information, a notification type and content of the notification when it is detected that the notification is to be presented; and
select, based on the notification type, at least two clients from amongst the plurality of clients and send the content of the notification to the at least two clients,
wherein the at least two clients are configured to generate and render their respective user interfaces, based on the content of the notification, to present the notification substantially simultaneously.

2. The system of claim 1, wherein the control server is configured to:
determine, based on the notification type, an expiration time of the notification; and
trigger the at least two clients to remove the notification when the expiration time of the notification has passed,
wherein, when triggered, the at least two clients are configured to update and render their respective user interfaces to remove the notification substantially simultaneously.

3. The system of claim 1, wherein the control server is configured to:
detect whether or not a user has dismissed the notification; and
trigger the at least two clients to remove the notification when it is detected that the user has dismissed the notification,
wherein, when triggered, the at least two clients are configured to update and render their respective user interfaces to remove the notification substantially simultaneously.

4. The system of claim 1, wherein a given client from amongst the plurality of clients is configured to:
detect whether or not a notification is to be presented; and
send, to the control server, information about the notification when it is detected that the notification is to be presented,
wherein the control server is configured to:
determine, based on the information about the notification, a notification type and content of the notification; and
select, based on the notification type, at least two clients from amongst the plurality of clients and send the content of the notification to the at least two clients, wherein the at least two clients comprise the given client,
wherein the at least two clients are configured to generate and render their respective user interfaces, based on the content of the notification, to present the notification substantially simultaneously.

5. The system of claim 4, wherein the given client is configured to send, to the control server, a message indicating when the notification is to be removed,
wherein the control server is configured to trigger the at least two clients to remove the notification, based on the message, wherein, when triggered, the at least two clients are configured to update and render their respective user interfaces to remove the notification substantially simultaneously.

6. The system of claim 1, wherein the control server is configured to define a plurality of notification types and associate with a given notification type at least two clients from amongst the plurality of clients that are configured to generate notifications of the given notification type.

7. The system of claim 1, wherein the content of the notification comprises at least one of: text, an image, a video clip, an audio clip, a Uniform Resource Locator (URL) link.

8. The system of claim 1, wherein the notification indicates at least one of: an error code of an error encountered by the display device or the at least one external computing device, an action to be taken by the user to fix the error, technical details related to the error.

9. A method of presenting notifications on a head-mounted display device and at least one external computing device, the display device comprising at least one image renderer, an external visual indicator and a first processor, the at least one external computing device comprising a display and a second processor, the at least one external computing device being communicably coupled with the display device, wherein a first client and a second client from amongst a plurality of clients are executed on the first processor to generate and render a first user interface and a second user interface on the at least one image renderer and the external visual indicator, respectively, and wherein a third client from amongst the plurality of clients is executed on the second processor to generate and render a third user interface on the display, wherein the method comprises:
obtaining, at a control server executing on the first processor or the second processor, information indicative of at least one of: a current status of an extended-reality scene being presented via the at least one image renderer, an error encountered by the display device indicating whether or not the components of the display device are working properly, an error encountered by the at least one external computing device indicating whether or not the components of the at least one external computing device are working properly, a user input received by the display device, a user input received by the at least one external computing device indicating an icon selection;
detecting, at the control server, whether or not a notification is to be presented, based on the obtained information;
determining, at the control server, a notification type and content of the notification when it is detected that the notification is to be presented, wherein the notification type and the content of the notification are determined based on the obtained information;
selecting, at the control server, at least two clients from amongst the plurality of clients based on the notification type and sending the content of the notification to the at least two clients; and
generating, at the at least two clients, their respective user interfaces based on the content of the notification, and rendering their respective user interfaces to present the notification substantially simultaneously.

10. The method of claim 9, further comprising:
determining, at the control server, an expiration time of the notification based on the notification type; and
triggering the at least two clients to remove the notification when the expiration time of the notification has passed, wherein the at least two clients update and render their respective user interfaces to remove the notification substantially simultaneously.

11. The method of claim 9, further comprising:
detecting, at the control server, whether or not a user has dismissed the notification; and
triggering the at least two clients to remove the notification when it is detected that the user has dismissed the notification, wherein the at least two clients update and render their respective user interfaces to remove the notification substantially simultaneously.

12. The method of claim 9, further comprising:
detecting, at a given client from amongst the plurality of clients, whether or not a notification is to be presented;
sending, to the control server, information about the notification when it is detected that the notification is to be presented;
determining, at the control server, a notification type and content of the notification based on the information about the notification;
selecting, at the control server, at least two clients from amongst the plurality of clients based on the notification type and sending the content of the notification to the at least two clients, wherein the at least two clients comprise the given client; and
generating, at the at least two clients, their respective user interfaces based on the content of the notification, and rendering their respective user interfaces to present the notification substantially simultaneously.

13. The method of claim 12, further comprising:
sending, from the given client to the control server, a message indicating when the notification is to be removed; and
triggering the at least two clients to remove the notification based on the message, wherein the at least two clients update and render their respective user interfaces to remove the notification substantially simultaneously.

14. The method of claim 9, further comprising:
defining, at the control server, a plurality of notification types; and
associating with a given notification type at least two clients from amongst the plurality of clients that are configured to generate notifications of the given notification type.

15. The method of claim 9, wherein the content of the notification comprises at least one of: text, an image, a video clip, an audio clip, a Uniform Resource Locator (URL) link.

16. The method of claim 9, wherein the notification indicates at least one of: an error code of an error encountered by the display device or the at least one external computing device, an action to be taken by the user to fix the error, technical details related to the error.
